(19) United States
(12) Patent Application Publication
(10) Pub. No.: US 2025/0348978 A1
(43) Pub. Date: Nov. 13, 2025

(54) ELECTRONIC DEVICE, METHOD, AND NON-TRANSITORY COMPUTER READABLE STORAGE MEDIUM FOR RESTORING LOW-RESOLUTION IMAGE BY USING IMAGE RESTORATION MODEL FOR EXTRACTING GLOBAL CONTEXT INFORMATION

(71) Applicant: THINKWARE CORPORATION, Seongnam-si (KR)

(72) Inventors: Dongwoo PARK, Seongnam-si (KR); Hyunsuk OH, Seongnam-si (KR)

(21) Appl. No.: 19/206,175

(22) Filed: May 13, 2025

(30) Foreign Application Priority Data
May 13, 2024 (KR) 10-2024-0062807

(51) Int. Cl. G06T 5/60; G06T 5/50; G06T 5/73; G06V 10/32; G06V 10/77; G06V 10/778; G06V 20/62; G06V 30/166; G06V 30/19

(52) U.S. Cl. CPC G06T 5/60; G06T 5/50; G06T 5/73; G06V 10/32; G06V 10/7715; G06V 10/778; G06V 20/625; G06V 30/166; G06V 30/19127; G06V 30/19147; G06T 2207/20081; G06T 2207/20084; G06V 2201/03

(57) ABSTRACT

According to an embodiment, an electronic device receives a request to restore a second input image with a first resolution representing a specified portion of a first input image to an output image with a second resolution exceeding the first resolution. The electronic device, based on the received request, executes an image restoration model including a first encoder for extracting first feature information from the first input image, a second encoder for extracting second feature information from the second input image, and a decoder for generating the output image with the second resolution based on multi head cross attention between the first feature information and the second feature information. The electronic device provides the output image with the second resolution obtained based on the execution of the image restoration model, as a response to the request.

### TECHNICAL FIELD

This disclosure relates to an electronic device, a method, and a non-transitory computer-readable storage medium for restoring a low-resolution image using an image restoration model for extracting global context information.

### BACKGROUND ART

Technology for processing a photo and/or a video using artificial intelligence is being developed. For example, technology for classifying a subject (e.g., an object including a person, an animal, and/or a vehicle) captured by the photo and/or the video is being developed. For example, technology for recognizing one or more characters (or strings) related to the photo and/or the video is being developed.

The above-described information may be provided as a related art for the purpose of helping understanding of the present disclosure. No claim or determination is raised as to whether any of the above-described descriptions may be applied as the prior art related to the present disclosure.

### SUMMARY

### Technical Solution

According to an embodiment, an electronic device may comprise memory storing instructions. The electronic device may comprise at least one processor configured to execute the instructions. The instructions, when executed by the at least one processor individually or collectively, may cause the electronic device to receive a request to restore a second input image with a first resolution representing a specified portion of a first input image to an output image with a second resolution exceeding the first resolution. The instructions, when executed by the at least one processor individually or collectively, may cause the electronic device to, based on the received request, execute an image restoration model including a first encoder for extracting first feature information from the first input image, a second encoder for extracting second feature information from the second input image, and a decoder for generating the output image with the second resolution based on multi head cross attention between the first feature information and the second feature information. The instructions, when executed by the at least one processor individually or collectively, may cause the electronic device to provide the output image with the second resolution obtained based on the execution of the image restoration model, as a response to the request.

According to an embodiment, a method executed in an electronic device may be provided. The method may comprise receiving a request to restore a second input image with a first resolution representing a specified portion of a first input image to an output image with a second resolution exceeding the first resolution. The method may comprise, based on the received request, executing an image restoration model including a first encoder for extracting first feature information from the first input image, a second encoder for extracting second feature information from the second input image, and a decoder for generating the output image with the second resolution based on multi head cross attention between the first feature information and the second feature information. The method may comprise providing the output image with the second resolution obtained based on the execution of the image restoration model, as a response to the request.

In an embodiment, a non-transitory computer readable storage medium including instructions may be provided. The instructions may be configured, when executed by at least one processor of an electronic device individually or collectively, to cause the electronic device to receive a request to restore a second input image with a first resolution representing a specified portion of a first input image to an output image with a second resolution exceeding the first resolution. The instructions may be configured, when executed by the at least one processor individually or collectively, to cause the electronic device to, based on the received request, execute an image restoration model including a first encoder for extracting first feature information from the first input image, a second encoder for extracting second feature information from the second input image, and a decoder for generating the output image with the second resolution based on multi head cross attention between the first feature information and the second feature information. The instructions may be configured, when executed by the at least one processor individually or collectively, to cause the electronic device to provide the output image with the second resolution obtained based on the execution of the image restoration model, as a response to the request.

According to an embodiment, a method of an electronic device may be provided. The method may comprise, using a first input image, a second input image with a first resolution representing a specified portion of the first input image, and a ground truth image with a second resolution exceeding the first resolution, executing training of an image restoration model including a first encoder for extracting first feature information from the first input image, a second encoder for extracting second feature information from the second input image, and a decoder for generating an output image with the second resolution, based on multi head cross attention between the first feature information and the second feature information. The method may comprise providing the image restoration model, as a portion of a software application for restoring of an image. The method may comprise executing training of the second encoder, based on loss between the output image and the ground truth image.

### BRIEF DESCRIPTION OF THE DRAWINGS

FIG. 1 illustrates an exemplary block diagram of an electronic device for restoring at least a portion of an image.

FIG. 2 illustrates an exemplary block diagram of an image restoration model executed by an electronic device according to an embodiment.

FIG. 3 illustrates an exemplary block diagram of a model for global context information and a model for local information included in an image restoration model executed by an electronic device according to an embodiment.

FIG. 4 illustrates an exemplary block diagram of a model for prior knowledge information included in an image restoration model executed by an electronic device according to an embodiment.

FIG. 5 illustrates an exemplary block diagram of a teacher model connected to a model for prior knowledge information included in an image restoration model executed by an electronic device according to an embodiment.

FIG. 6 illustrates an exemplary block diagram of a structure for combining global context information and local information in an image restoration model executed by an electronic device according to an embodiment.

FIG. 7 illustrates an exemplary block diagram of a structure for combining global context information, local information, and prior knowledge information in an image restoration model executed by an electronic device according to an embodiment.

FIGS. 8A and 8B illustrate at least one license plate (or number plate), which is a subject included in an image restored by an image restoration model according to an embodiment.

### DETAILED DESCRIPTION OF EXEMPLARY EMBODIMENTS

Hereinafter, various embodiments of the present document will be described with reference to the accompanying drawings.

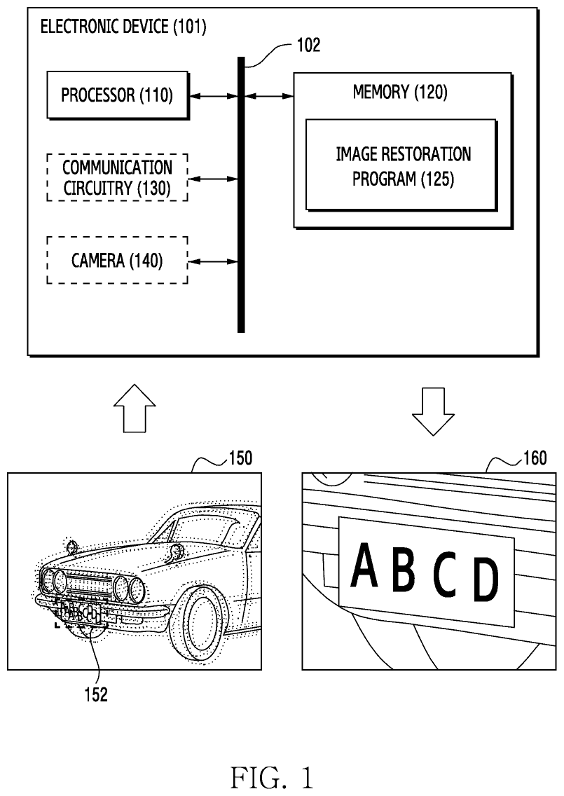

FIG. 1 illustrates an exemplary block diagram of an electronic device 101 to restore at least a portion of an image 150. The electronic device 101 may be configured to at least partially restore or enhance the image 150. Restoring or enhancing the image 150 may include an operation of improving visibility of a subject represented by the image 150 by compensating for distortion included in the image 150, such as blur, afterimage, and optical flow.

Referring to FIG. 1, the image 150 including a portion 152 associated with a license plate (or a number plate) is exemplarily illustrated. For example, the image 150 may be transmitted from an external electronic device to the electronic device 101 through communication circuitry 130. For example, the image 150 may be obtained using a camera 140 included in the electronic device 101. For example, the image 150 may be a file with a format based on a joint photographic experts group (jpeg). For example, the image 150 may include raw data obtained from the camera 140. For example, the image 150 may be included in a sequence (e.g., a video) of image frames, which is included in a video and set to be displayed sequentially. A means for obtaining or receiving the image 150 is not limited to the communication circuitry 130 and/or the camera 140 illustrated in FIG. 1.

Referring to the exemplary image 150 of FIG. 1, an exemplary subject such as a vehicle may be captured. The image 150 may be distorted according to an environment in which a subject is photographed. For example, in case that the subject is moving (e.g., driving of a vehicle), and/or a camera (e.g., the camera 140) controlled to obtain the image 150 is moving (or shaking), an appearance of the subject represented by pixels of the image 150 may be distorted. According to an embodiment, the electronic device 101 may enable the appearance of the subject represented by the image 150 to be clear, by at least partially reducing or removing the distortion generated in the image 150.

Referring to FIG. 1, an exemplary hardware configuration of the electronic device 101 to at least partially restore the image 150 is illustrated. For example, the electronic devices 101 may include a personal computer such as a laptop and a desktop, a smartphone, a smart pad, and a tablet PC. For example, the electronic device 101 may include a smart accessory such as a smartwatch, a smart ring, and/or a head-mounted device (HMD). For example, the electronic device 101 may be referred to as a mobile device, user equipment (UE), a multifunction device, a portable communication device, and/or a portable device. For example, the electronic device 101 may be included as an electronic control unit (ECU) in a vehicle (e.g., an electric vehicle (EV)). For example, the electronic device 101 may include a server of a service provider that provides a service for restoring the image 150. The server may include one or more PCs and/or workstations.

Referring to FIG. 1, according to an embodiment, the electronic device 101 may include at least one of a processor 110, memory 120, the communication circuitry 130, or the camera 140. According to an embodiment, the communication circuitry 130 and/or the camera 140 may not be included in the electronic device 101. For example, the communication circuitry 130 and/or the camera 140 may be disposed outside the electronic device 101 and may be electrically connected to the electronic device 101.

Referring to FIG. 1, the processor 110, the memory 120, the communication circuitry 130, and the camera 140 may be electronically and/or operably coupled with each other by an electronical component such as a communication bus 102. Hereinafter, electronical components being operably combined may mean that a direct connection or an indirect connection between first electronical components and second electronical components is established by wire or wirelessly so that a second electronical component is controlled by a first electronical component. Although illustrated based on different blocks, an embodiment is not limited thereto, and a portion of (e.g., at least a portion of the processor 110, the memory 120, and the communication circuitry 130) the electronical components of FIG. 1 may be included in a single integrated circuit such as a system on a chip (SoC). A type and/or the number of electronical components included in the electronic device 101 is not limited as illustrated in FIG. 1. For example, the electronic device 101 may include only a portion of the electronical components illustrated in FIG. 1.

The processor 110 of the electronic device 101 according to an embodiment may include circuitry (e.g., processing circuitry) for processing data based on one or more instructions. The circuitry for processing data may include, for example, an arithmetic and logic unit (ALU), a floating point unit (FPU), a field programmable gate array (FPGA), a central processing unit (CPU), a graphic processing unit (GPU), a neural processing unit (NPU), and/or an application processor (AP). For example, the number of the processors 110 may be one or more. The processing circuitry of the processor 110 that loads (or fetches) an instruction and performs a calculation corresponding to the loaded instruction may be referred to or referenced as core circuitry (or a core). For example, the processor 110 may have a structure of a multi-core processor including a plurality of core circuitries, such as a dual core, a quad core, a hexa core, or an octa core. A function and/or an operation described with reference to the present disclosure may be individually and/or collectively performed by one or more processing circuitries included in the processor 110.

According to an embodiment, the memory 120 of the electronic device 101 may include circuitry for storing data and/or an instruction inputted and/or outputted to the processor 110. The memory 120 may include, for example, volatile memory such as random-access memory (RAM) and/or non-volatile memory such as read-only memory (ROM). The non-volatile memory may be referred to as storage. The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multi media card (eMMC). The memory 120 may include one or more storage mediums (e.g., the volatile memory and/or nonvolatile memory described above) positioned in the electronic device 101 in a distributed manner. The processor 110 of the electronic device 101 may perform a function and/or an operation indicated by instructions, by executing the instructions of the memory 120 in the electronic device 101. For example, in case that the electronic device 101 includes at least one processor, the at least one processor may be configured to execute the instructions collectively or individually.

According to an embodiment, the communication circuitry 130 of the electronic device 101 may include hardware for supporting transmission and/or reception of an electrical signal between the electronic device 101 and the external electronic device (e.g., a user terminal configured to transmit the image 150). The communication circuitry 130 may include at least one of, for example, a modem, an antenna, and an optic/electronic (O/E) converter. The communication circuitry 130 may support transmission and/or reception of an electrical signal based on various types of protocols, such as Ethernet, a local area network (LAN), a wide area network (WAN), wireless fidelity (WiFi), near field communication (NFC), Bluetooth, bluetooth low energy (BLE), ZigBee, long term evolution (LTE), fifth generation (5G), a new radio (NR), sixth generation (6G), and/or above-6G.

According to an embodiment, the camera 140 of the electronic device 101 may include one or more optical sensors (e.g., a charged coupled device (CCD) sensor and a complementary metal oxide semiconductor (CMOS) sensor) that generate an electrical signal indicating a color and/or brightness of light. The plurality of optical sensors included in the camera 140 may be disposed in a form of a 2 dimensional array. The camera 140 may generate 2 dimensional frame data corresponding to light reaching the optical sensors of the 2 dimensional array, by obtaining an electrical signal of each of the plurality of optical sensors substantially simultaneously. For example, photo data captured using the camera 140 may mean a 2 dimensional frame data obtained from the camera 140. For example, video data captured using the camera 140 may mean a sequence of a plurality of 2 dimensional frame data obtained from the camera 140.

Referring to FIG. 1, the processor 110 of the electronic device 101 according to an embodiment may at least partially restore or enhance the image 150 by executing an image restoration program 125. The processor 110 (e.g., the CPU, the GPU, and/or the NPU) executing the image restoration program 125 may perform calculations for restoring the image 150. The calculations may be associated with a calculation model (e.g., an artificial neural network, and/or a neural network) configured to simulate a neural activity of a living organism. The neural activity may include, for example, a cognitive activity, an inference activity, and/or a creative activity of a living organism. For example, instructions indicating the calculation model, formulas associated with the calculation model, and/or a constant (e.g., coefficients and/or weights) included in the formulas, may be at least partially included in the image restoration program 125.

According to an embodiment, the processor 110 of the electronic device 101 may restore or enhance the portion 152 (e.g., a portion of an object in which one or more characters are printed is captured, such as a number plate and/or a sign plate) in which at least one character is captured, in the image 150. For example, in the image 150, the electronic device 101 may extract or segment (or crop) the portion 152 associated with at least one character. The portion 152 may be referred to as a region of interest (ROI). The processor 110 may restore or enhance the portion 152 by executing the image restoration program 125.

In an embodiment, the electronic device 101 may increase or enhance a resolution of a scene by recognizing text (e.g., text that is indicated as being captured or included in the scene) associated with the scene such as the image 150. For example, in case of detecting one or more characters from a scene of a relatively low resolution (or small size), the electronic device 101 may generate another scene corresponding to the scene and having a higher resolution (or a larger size) than the resolution of the scene, by using a shape and/or an appearance of the detected one or more characters. For example, with respect to a scaling factor f, from a scene with a width w and a height h, the electronic device 101 may generate or output a scene with a width fw and a height fh.

In an embodiment, in terms of recognizing text and generating a high-resolution scene, the image restoration program 125 and/or artificial intelligence driven by the image restoration program 125 may be referred to as a scene text image super-resolution (STISR) and/or a model for the STISR. A performance of the STISR may be evaluated using accuracy (e.g., STISR accuracy) of a character included in the high-resolution scene generated by executing the STISR.

Referring to FIG. 1, an image 160 that the electronic device 101 outputs as a result of restoring the portion 152 of the image 150 is illustrated. The image 150 and/or the portion 152 may be referred to as an input image in terms of being inputted to the processor 110 of the electronic device 101. The image 160 may be referred to as an output image in terms of output data corresponding to the input image. According to an embodiment, the electronic device 101 may obtain information indicating one or more characters associated with the portion 152 by using an artificial intelligence model trained to recognize one or more characters from an image. By using the information, the electronic device 101 may generate or output the image 160 as a high-resolution image corresponding to the portion 152.

Referring to FIG. 1, the image 160 may have a larger size than the portion 152 and/or a higher resolution than the portion 152. Dimensions (e.g., a width and/or a height) of the image 160 may be greater than dimensions of the portion 152. For example, the image 160 may have the same dimensions and/or resolution as the image 150. In an embodiment of receiving the image 150 and/or the portion 152 from the external electronic device through the communication circuitry 130, the electronic device 101 may receive a request for restoring the portion 152 of the image 150 with a first resolution to the image 160 with a second resolution greater than the first resolution. From a signal received from the external electronic device, the electronic device 101 may identify or detect the image 150 and/or the portion 152. The signal may include a command and/or an operand indicating the request for restoration of the portion 152. In an embodiment of receiving the entire image 150 including the portion 152, the processor 110 of the electronic device 101 may extract or segment the portion 152 in which a subject relation to one or more characters is captured, such as a number plate. The portion 152 may be used as an image used for restoration.

Based on the request for restoring the image 150 and/or the portion 152, the electronic device 101 may execute an artificial intelligence model (e.g., an image restoration model) provided by the image restoration program 125. The electronic device 101 may provide the image 160 of the second resolution, obtained based on the execution of the image restoration model, as a response to the request. For example, the electronic device 101 may transmit a signal including the image 160 to the external electronic device through the communication circuitry 130.

In an embodiment, the image restoration model executed by the image restoration program 125 may include an image encoder trained to extract structural feature information and/or logits information of an input image (e.g., the entire image 150) inputted to the image restoration model. The image encoder may be trained to extract summarized (or in a reduced dimension) information of the image 150 to specify or distinguish the image 150. The image encoder may be trained to extract information including positions and/or features of one or more pixels uniquely included in the image 150, such as a feature point (or a key point) and/or a boundary line. For example, the information outputted from the image encoder may be referred to as global context information in terms of including the features with respect to the entire image 150.

In an embodiment, the image restoration model executed by the image restoration program 125 may include an encoder trained to extract structural feature information and/or logits information of an input image (e.g., the portion 152) inputted to the image restoration model. The encoder may be trained to extract summarized (or in a reduced dimension) information of the portion 152 to specify or distinguish the portion 152. The encoder may be trained to extract information including positions and/or features of one or more pixels uniquely included in the portion 152, such as a feature point (or a key point) and/or a boundary line. For example, the information outputted from the encoder may be referred to as local information in terms of including the features with respect to the portion 152. For example, the information outputted from the encoder may be referred to as non-textual information in terms of representing the structural feature information and/or the logits information of the portion 152.

In an embodiment, the image restoration model executed by the image restoration program 125 may include a sub-model trained to recognize one or more characters (e.g., represented to be captured by the input image) associated with the input image (e.g., the portion 152) inputted to the image restoration model. The sub-model, which is information (e.g., explicit information) readable by the processor 110 executing a software application distinct from the image restoration model and/or the image restoration program 125, may be trained to output information indicating the one or more characters associated with the input image, degrees to which each of the one or more characters is associated with the input image (e.g., probabilities that one or more characters are captured by the input image), and/or a positional relationship of the one or more characters (e.g., a position and/or an order of each of the one or more characters in a string).

For example, the information outputted from the sub-model may be referred to as text probability information in terms of including probabilities indicating text represented to be captured by the input image. The text probability information may be referred to as text categorical information, a text probability, a text probability map, text prior information, and/or text distribution. For example, the text probability information may include category information of text and/or information indicating a visual cue for text in an image.

According to an embodiment, the electronic device 101 may be trained to generate the image 160 using an intermediate state and/or intermediate information of the sub-model trained to output explicit information such as the text probability information. For example, among nodes (e.g., perceptrons) of the sub-model, which are distinguished by a plurality of layers, values of nodes that are different from nodes of an output layer including nodes corresponding to each element of the text probability information may be directly transmitted to another sub-model of the image restoration model. For example, an intermediate layer of the sub-model may be connected to the other sub-model of the image restoration model.

For example, values of nodes included in the intermediate layer may be implicit information that is distinct from explicit information. The implicit information may include more detailed information with respect to an input image than text probability information, which includes only probabilities that the input image (e.g., the portion 152 and/or the image 150) corresponds to each of a plurality of characters. By executing the image restoration model using the implicit information, the electronic device 101 may restore the portion 152 more accurately.

For example, the electronic device 101 may obtain or generate the image 160 that more accurately represents one or more characters included in the portion 152. In the example, since one or more characters are more accurately recognized or represented from the portion 152 when receiving requests to repeatedly restore the portion 152, a plurality of images (e.g., the image 160) generated in response to the requests may include similar characters to each other.

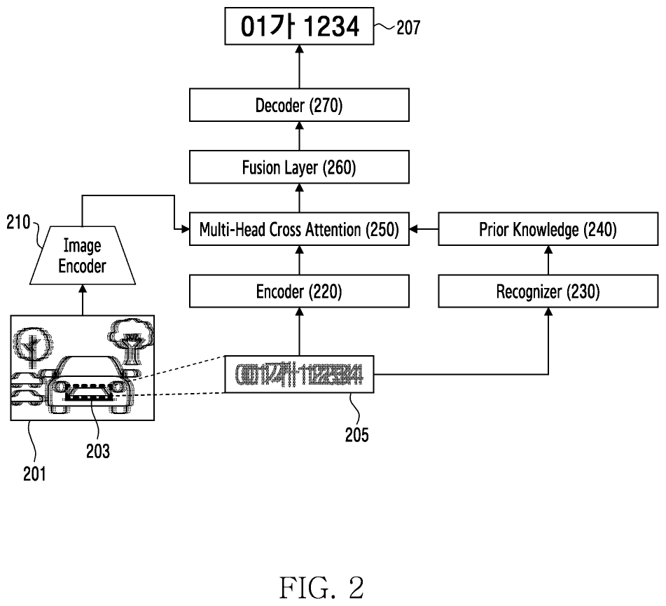

Hereinafter, an exemplary structure of the image restoration model executed by the image restoration program 125 and a process of training the image restoration model will be exemplarily described with reference to FIGS. 2 to 5.

FIG. 2 illustrates an exemplary block diagram of an image restoration model executed by an electronic device according to an embodiment.

The electronic device 101 and/or the processor 110 of FIG. 1 may execute an image restoration model described with reference to FIG. 2 by executing an image restoration program 125.

Hereinafter, an operation of executing an artificial intelligence model, such as the image restoration model, may include operations of performing one or more calculations associated with the artificial intelligence model by using a processor device (e.g., the processor 110 of FIG. 1 including the GPU and/or the NPU) of the electronic device. The operation of executing the artificial intelligence model may include an operation of inputting commands (or instructions) indicating the calculations to the GPU and/or the NPU to perform the calculations by the GPU and/or the NPU. The operation of executing the artificial intelligence model may include an operation of inputting data (e.g., an input image such as an entire image 201 and/or a partial image 205) to be at least partially changed by the calculations to the GPU and/or the NPU. Although the operation of executing the artificial intelligence model based on the GPU and/or the NPU has been exemplarily described, an embodiment is not limited thereto, and an operation of executing the artificial intelligence model using a CPU may also be performed similarly to the above-described operation.

Referring to FIG. 2, calculations performed by the image restoration model are illustrated as a plurality of blocks for distinguishing types and/or an order of the calculations. Any one block of FIG. 2 may correspond to a group of the calculations performed while executing the artificial intelligence model (e.g., the image restoration model). Each of the blocks of FIG. 2 may be referred to as an operation, layer(s), a sub-model and/or a module for the artificial intelligence model. Referring to FIG. 2, the image restoration model including a (pre-trained) image encoder 210 is exemplarily illustrated to extract (or obtain) global context information.

In an embodiment, the image restoration model may include the image encoder 210. In an embodiment, the image encoder 210 may be a pre-trained encoder for extracting feature information from the entire image 201. The feature information (e.g., structural feature information and/or logits information) on the entire image 201 obtained from the image encoder 210 may be referred to as the global context information. The global context information may include summarized (or in a reduced dimension) information of the entire image 201 to specify or distinguish the entire image 201. The global context information may include positions and/or characteristics of one or more pixels uniquely included in the entire image 201, such as a feature point (or key point) and/or a boundary line. According to embodiments, the image encoder 210 may be referred to as a first encoder.

In an embodiment, the image encoder 210 may be a pre-trained encoder on a relationship between visual information and language information. For example, the image encoder 210 may be a model that aligns the relationship between the visual information and the language information on an embedding space. In an embodiment, the image encoder 210 may be referred to as an image-language model in terms of being trained based on the relationship between the visual information and the language information. In an embodiment, the image encoder 210 may include at least one of encoders (e.g., an image encoder, and a text encoder) included in a Contrastive Language-Image Pre-training (CLIP). However, it is not limited thereto. In an embodiment, the image encoder 210 may include an encoder (or an image encoder) included in a bootstrapping language-image pre-training (BLIP), or self-distillation with no labels (DINO).

In an embodiment, the image encoder 210 may cause the electronic device 101 executing the image restoration model to generate an output image 207 using the global context information inferred from the entire image 201.

In an embodiment, the image restoration model may include an encoder 220. In an embodiment, the encoder 220 may be an encoder for extracting (low level) feature information from the partial image 205. In an embodiment, the encoder 220 may include a convolutional neural network (CNN) with less loss of structural information (or spatial information) required for image restoration. The shallow CNN may include a fewer number of layers than a backbone network (e.g., ResNet including 50 or more convolutional layers) having a structure in which a large number of layers are connected in series for feature extraction. The backbone network may be trained to perform a high-level vision task of calculating a class vector from a high-resolution image, such as a classification task. The encoder (or STISR) of the image restoration model may include a relatively small number of layers to reduce loss of structural information (or spatial information) of a low-resolution image when extracting features of the low-resolution image to perform a low-level vision task (e.g., a task increasing resolution of the image). In an embodiment, the encoder 220 may extract feature information at a lower level than that of the image encoder 210. In an embodiment, by executing the encoder 220, the electronic device 101 may generate (or obtain) feature information on the partial image 205. In an embodiment, the feature information on the partial image 205 may be referred to as local information in terms of being obtained as the partial image 205 is segmented (or cropped) from a portion 203 of the entire image 201. In an embodiment, the feature information on the partial image 205 may be referred to as local information obtained as a result of a crop algorithm for extracting the portion 203 of the entire image 201, based on a region of interest (RoI) obtained as a result of an algorithm for finding the region of interest, such as object detection or object segmentation. Feature information obtained by inputting the partial image 205 to the encoder 220 may be referred to as non-textual information (e.g., structural feature information). The feature information on the partial image 205 obtained from the encoder 220 may be referred to as low-level feature information. In the feature information (or the local information), spatial information (e.g., a width, and a height) for utilizing a structural feature of the partial image 205 may be maintained. The feature information (or the local information) may be obtained through mapping to a channel having a higher dimension than a dimension of the partial image 205.

In an embodiment, the encoder 220 may cause the electronic device 101 executing the image restoration model to generate the output image 207 using the non-textual information inferred from the partial image 205.

For example, the image restoration model may include a recognizer 230 for determining a text probability map for the partial image 205. An output layer of the recognizer 230 may include values determined by calculations performed for a linearization operation. The values included in the output layer may be text probability information. In an embodiment, the recognizer 230 may be trained to recognize one or more characters from a scene such as the partial image 205. The recognizer 230 may be referred to as a scene-text recognizer (STR) and/or a STR model from a viewpoint of recognizing characters. The recognizer 230 may be configured to recognize or process features such as a shape and/or a position of the one or more characters in the partial image 205.

Referring to FIG. 2, the output layer of the recognizer 230 may be related to the linearization operation. Within the recognizer 230, (implicit) information that includes a result of performing a decoding prediction operation (or a state of any one intermediate layer for the decoding prediction operation), and is to be used for the linearization operation, may be provided to a multi head cross attention model 250. Information outputted by the recognizer 230 (e.g., information transmitted to the multi head cross attention model 250) may be referred to as prior knowledge information 240. The information on the partial image 205 obtained from the recognizer 230 may be referred to as textual information. The textual information on the partial image 205 and the non-textual information on the partial image 205 may be referred to as local information on the partial image 205.

In an embodiment, the recognizer 230 may cause the electronic device 101 executing the image restoration model to generate the output image 207 using the textual information (e.g., text probability information) inferred from the partial image 205.

In an embodiment, the multi head cross attention model 250 may cause the electronic device 101 executing the image restoration model to generate the output image 207 using the global context information inferred from the entire image 201 and the local information inferred from the partial image 205 (e.g., the prior knowledge information 240 (or the textual information) and/or the low-level feature information (or the non-textual information)). From a viewpoint of using the global contextual information and the local information, the image restoration model may be a model that supports multimodal.

In an embodiment, the multi head cross attention model 250 may cause the electronic device 101 executing the image restoration model to perform multi head cross attention using the global context information and the local information. For example, the electronic device 101 executing the image restoration model may perform the multi head cross attention by using one (e.g., the low-level feature information) of the low-level feature information or the global context information as a query and the other (e.g., the global context information) as a key and a value. For example, the electronic device 101 executing the image restoration model may perform the multi head cross attention by using one (e.g., the low-level feature information) of the low-level feature information or the prior knowledge information 240 as a query and the other (e.g., the prior knowledge information 240) as a key and a value.

Referring to FIG. 2, a fusion layer 260 may be configured to combine computation results of the multi head cross attention model 250. For example, the fusion layer 260 may be configured to combine the multi head cross attention between the low-level feature information and the global context information and the multi head cross attention between the low-level feature information and the prior knowledge information 240.

Referring to FIG. 2, the image restoration model may perform decoder operation 270 to generate the output image 207 with a resolution higher than that of the partial image 205, using information generated by the fusion layer 260. The decoder operation 270 may be trained to generate the output image 207 that has a resolution higher than that of the partial image 205 and/or a size wider than that of the partial image 205, and is associated with the partial image 205 (e.g., including content of the partial image 205), using the information generated by the fusion layer 260. The output image 207 may be provided as a result of restoring or enhancing the partial image 205.

As described above, the electronic device 101 may perform restoration of the entire image 201 and/or the partial image 205 through the entire image 201 including abundant information and the partial image 205 for a specified portion (e.g., a license plate). Accordingly, as described above, by using the entire image 201 including the abundant information, since the partial image 205 has less feature information as a size of the specified portion (e.g., the license plate) is smaller, the electronic device 101 may reduce a problem of increasing a difficulty of restoring a correct character included in the partial image 205.

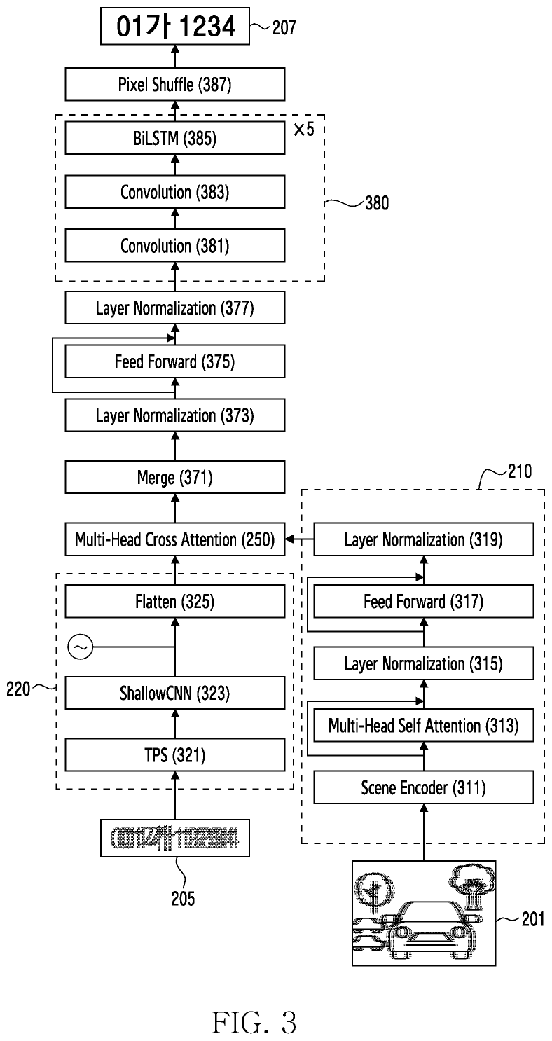

FIG. 3 illustrates an exemplary block diagram of a model for global context information and a model for local information included in an image restoration model executed by an electronic device according to an embodiment.

The electronic device 101 and/or the processor 110 of FIG. 1 may execute or train the image restoration model described with reference to FIG. 3 by executing an image restoration program 125.

Referring to FIG. 3, an encoder 220 of the image restoration model may include a thin plate spline (TPS) model 321, a shallow CNN 323, and a Flatten model 325. From a partial image 205, an electronic device 101 may extract low-level feature information by performing calculations represented by the TPS model 321 and the shallow CNN 323. By combining the feature information with position embedding data for a synthesis operation, the electronic device 101 may obtain the low-level feature information (or non-textual information) of [symbol] ^{c×hw}. The C of [symbol] ^{c×hw}, which is a number representing a dimension of the feature information, may correspond to the number (a feature dimension generated as an RGB channel of an input image passes through the shallow CNN 323) of dimensions of information outputted from an output layer of the shallow CNN 323. The hw of [symbol] ^{c×hw} may represent a size (e.g., the number of parameters aligned in one dimension) of information (e.g., one-dimensional information) that flattens information (e.g., a height and a width of an image) of the partial image 205.

By performing the calculations represented by the TPS model 321, the electronic device 101 may adjust shapes of characters in the partial image 205 so that the characters have uniform shapes. For example, low-level feature information outputted from the Flatten model 325 connected to the shallow CNN 323 may correspond to Fᵥ of Equation 1.

$${F}_{v} = Flatten ( {Enc}_{1} ( TPS ( {x}_{LR} ) ) + P E ) \qquad [ Equation 1 ]$$

The x_{LR} of Equation 1 may represent the partial image 205 with a relatively low resolution. The PE of Equation 1 may represent position embedding data combined with feature information of the shallow CNN 323. The Flatten of Equation 1 may represent an operation of converting multidimensional information into one-dimensional information. The Enc₁ of Equation 1 may represent an operation performed in the shallow CNN 323. The image restoration model according to an embodiment may consider proximity between pixels in the image by using the position embedding data as an index indicating an importance between the pixels in the image. Therefore, in order to consider a distance between the pixels in the image while calculating the feature information, the image restoration model according to an embodiment may be trained to use information (e.g., the PE that is the position embedding data of Equation 1) indicating a spatial feature of the image.

In a state of processing an entire image 201 and the partial image 205 using the image restoration model, the electronic device 101 may perform a first operation of processing the partial image 205 using the encoder 220 and a second operation of processing the entire image 201 using an image encoder 210 in parallel (or substantially simultaneously). The first operation and the second operation may be performed substantially simultaneously by different processors included in the electronic device 101.

According to an embodiment, the electronic device 101 may process the entire image 201 using the image encoder 210. Within the image encoder 210, a scene encoder 311, a multi head self attention model 313, a first layer normalization model 315, a feed forward model 317, and a second layer normalization model 319 may be sequentially combined. Using the scene encoder 311 of the image encoder 210, the electronic device 101 may generate or obtain feature information F_{g}∈ [symbol] ^{1×c} (or global context information) having the number of channels of the C from the entire image 201 with a relatively high resolution of [symbol] ^{3×HW}. F_{g} of Equation 2 may represent the feature information (or the global context information) outputted from the scene encoder 311 of the image encoder 210.

$${F}_{g} = {Enc}_{2} ( {x}_{LR}^{′} ) \qquad [ Equation 2 ]$$

The

$${x}_{LR}^{′}$$

of Equation 2 may represent entire image 201 having a relatively high resolution. The Enc₂ of Equation 2 may represent an encoding operation performed by the scene encoder 311.

The electronic device 101 may perform multi head self attention on feature information F_{g} (or global context information) through the multi head self attention model 313. By performing multi head self attention on the feature information F_{g} obtained from the scene encoder 311, the electronic device 101 may obtain or calculate feature information

$${F}_{g}^{′}$$

### of Equation 3.

$${F}_{g}^{′} = LN ( softmax ( \frac{{Q}_{g} {K}_{g}^{T}}{\sqrt{d}} ) {V}_{g} + {F}_{g} ) \qquad [ Equation 3 ]$$

A query, a key and a value for performing multi head self attention of Equation 3 may correspond to the feature information F_{g} (or the global context information) of the entire image 201. The d of Equation 3 may represent a dimension of a key vector. The Q_{g}, the K_{g}, and the V_{g} of Equation 3, which are projections (e.g., projections based on an fc layer) of the F_{g} of Equation 2, may represent a query vector, a key vector, and value a vector, respectively. The LN of Equation 3 may represent a linearization operation. The

$${Q}_{g} {K}_{g}^{T}$$

operation of Equation 3 may represent an attention score of the self attention. The T operation of Equation 3 may represent a matrix transpose operation.

The electronic device 101 may obtain feature information

$${F}_{g}^{″}$$

of the feature information

$${F}_{g}^{′}$$

through the first layer normalization model 315, the feed forward model 317, and the second layer normalization model 319. The electronic device 101 may perform calculations represented by a serial connection of the first layer normalization model 315, the feedforward model 317, and the second layer normalization model 319. Referring to FIG. 3, a residual connection for an element-wise sum may be formed between the first layer normalization model 315 and the second layer normalization model 319. The residual connection may be formed between the first layer normalization model 315 and the second layer normalization model 319 independently of the feed forward model 317. In an embodiment, the feature information

$${F}_{g}^{″}$$

that is obtained from the second layer normalization model 319 and is to be inputted to the multi head cross attention model 250 may be represented as Equation 4.

$${F}_{g}^{″} = LN ( {F}_{g}^{′} \cdot {W}_{g} + {F}_{g}^{′} ) \qquad [ Equation 4 ]$$

The W_g of Equation 4, which is an fc layer (or weights of the fc layer), may represent a layer defined for a projection operation and an operation of the layer. According to an embodiment, the electronic device 101 may perform multi head cross attention between the low-level feature information Fᵥ∈ [symbol] ^{c×hw} of the encoder 220 and the global context information

$${F}_{g}^{″} ∈ {ℝ}^{1 \times c}$$

of the image encoder 210.

$${F}_{g}^{′′′}$$

of Equation 5 may represent feature information outputted from the multi head cross attention model 250. d

$${F}_{g}^{′′′} = LN ( softmax ( \frac{{Q}_{v} {K}_{g}^{″ T}}{\sqrt{d}} ) {V}_{g}^{″} ) \qquad [ Equation 5 ]$$

A query for performing multi head cross attention of Equation 5 may correspond to the low-level feature information Fᵥ∈ [symbol] ^{c×hw} of the encoder 220. A key and a value for performing the multi head cross attention of Equation 5 may correspond to the global context information

$${F}_{g}^{″} ∈ {ℝ}^{1 \times c}$$

of the image encoder 210.

The d of Equation 5 may represent a dimension of a key vector. The Qᵥ of Equation 5, which is a projection (e.g., the projection based on the fc layer) of the Fᵥ of Equation 1, may represent a query vector. The

$${K}_{g}^{″}$$

and the

$${V}_{g}^{″} ,$$

which are projections (e.g., the projections based on the fc layer) of the

$${F}_{g}^{″}$$

of Equation 4, may represent a key vector and a value vector, respectively. The LN of Equation 5 may represent a linearization operation. The

$${Q}_{g} \cdot {K}_{g}^{″ T}$$

operation of Equation 5 may represent an attention score of the self attention. The T operation of Equation 5 may represent a matrix transpose operation.

The key and the value for performing the multi head cross attention of Equation 5 may correspond to global context information having a size of

$${ℝ}^{1 \times c} ( e . g . , {K}_{g}^{″} , {V}_{g}^{″} ∈ {ℝ}^{l \times c} ) .$$

The [symbol] ^{l×c} may represent a feature dimension (the number) of the shallow CNN 323. The

$${Q}_{g} \cdot {K}_{p}^{″ T}$$

of Equation 5 may have a size of [symbol] ^{hw×l}, and the

$${Q}_{v} \cdot {K}_{g}^{″ T} \cdot {V}_{g}^{″}$$

of Equation 5 may have a size of [symbol] ^{hw×c}. Referring to Equation 5, the feature information

$${F}_{g}^{′′′}$$

obtained using a softmax operation and a layer normalization (LN) operation may be obtained from the multi head cross attention model 250.

With respect to the feature information

$${F}_{g}^{′′′}$$

obtained from the multi head cross attention model 250, the electronic device 101 may perform calculations represented by a serial connection of a merge model 371, a first layer normalization model 373, a feedforward model 375, and a second layer normalization model 377. Referring to FIG. 3, a residual connection for an element-wise sum may be formed between the first layer normalization model 373 and the second layer normalization model 377. The residual connection may be formed between the first layer normalization model 373 and the second layer normalization model 377 independently of the feed forward model 375.

Referring to FIG. 3, the electronic device 101 may repeatedly perform calculations based on a (bidirectional long-short term memory (BILSTM) model 385 N times (e.g., 5 times) with respect to the information obtained from the second layer normalization model 377. A combination of a first convolution model 381, a second convolution model 383, and the BiLSTM model 385 connected to the second layer normalization model 377 may be referred to as a decoder 380. In an embodiment, feature information F′ that is obtained from the second layer normalization model 377 and is to be inputted to the decoder 380 may be represented as Equation 6.

$${F}^{′} = LN ( F \cdot {W}_{f} + F ) \qquad [ Equation 6 ]$$

The W_{f} of Equation 6, which is an fc layer (or weights of the fc layer), may represent a layer defined for a projection operation and an operation of the layer. The F of Equation 6 may be feature information outputted from the merge model 371 based on the obtained feature information

$${F}_{g}^{′′′} .$$

The decoder 380 may have a sequential-recurrent block (SRB) structure in which calculations represented by the BiLSTM model 385 are repeatedly performed N times. The electronic device 101 may increase a resolution and/or a size of an image (e.g., an image represented by the feature information F′ of Equation 6) outputted by the decoder 380 by using a pixel shuffle model 387. For example, an output image 207 outputted from the pixel shuffle model 387 of the image restoration model may be determined based on Equation 7 and may correspond to a restored image, which is a result of Equation 7.

$$Restored Image = PixelSuffle ( SRB ( {F}_{v} , {F}^{′} ) ) \qquad [ Equation 7 ]$$

When training an image restoration model having a structure of FIG. 3, a loss function to be used for training the image restoration model may represent a difference between a ground truth image corresponding to the partial image 205 and the output image 207. For example, an L1 distance (e.g., a Manhattan distance and/or a rectangular street grid) between the ground truth image and the output image 207 may be determined as the loss function. An embodiment is not limited thereto, and a L2 distance (or mean squared loss), a structural similarity index (SSIM), a triplex SSIM (TSSIM), and a Kullback-Leibler (KL) divergence loss function for knowledge distillation may be used. For example, a loss function [symbol] ₛ based on the L2 distance may be defined as Equation 8.

$${ℒ}_{s} = {\vert {I}_{SR} - {I}_{HR} \vert}_{2} \qquad [ Equation 8 ]$$

The I_{SR} of Equation 8 may represent the output image 207, and the I_{HR} may represent the ground truth image. For training an image restoration model based on structural information of text, a loss function based on the TSSIM may be used, for example, such as a loss function [symbol] ₜₛₛᵢₘ of Equation 9.

$${ℒ}_{tssim} = 1 - TSSIM \qquad [ Equation 9 ]$$

$$such that TSSIM = \frac{( {μ}_{x} {μ}_{y} + {μ}_{y} {μ}_{z} + {μ}_{x} {μ}_{z} + {C}_{1} ) ( {σ}_{x y} + {σ}_{y z} + {σ}_{x z} + {C}_{2} )}{( {μ}_{x}^{2} + {μ}_{y}^{2} + {μ}_{Z}^{2} + {C}_{1} ) ( {σ}_{x}^{2} + {σ}_{x}^{2} + {σ}_{x}^{2} + {C}_{2} )}$$

The x of Equation 9 may correspond to a deteriorated output image 207, the y may correspond to the output image 207, and the z may correspond to the ground truth image. Each of μ and σ of Equation 9 is a mean and a standard deviation of corresponding images (e.g., the x, the y, and the z). The C of Equation 9 may be an epsilon value (e.g., a specified number set to prevent a zero division error, preferably C1=0.012, C2=0.032).

According to an embodiment, the electronic device may perform training on the image restoration model using the pre-trained image encoder 210. However, it is not limited thereto. In case that distribution of learning data for pre-training of the entire image 201 and the image encoder 210 is different, the image encoder 210 may also be trained together.

The trained image restoration model may be provided as a portion of a software application for image restoration (e.g., the image restoration program 125 of FIG. 1).

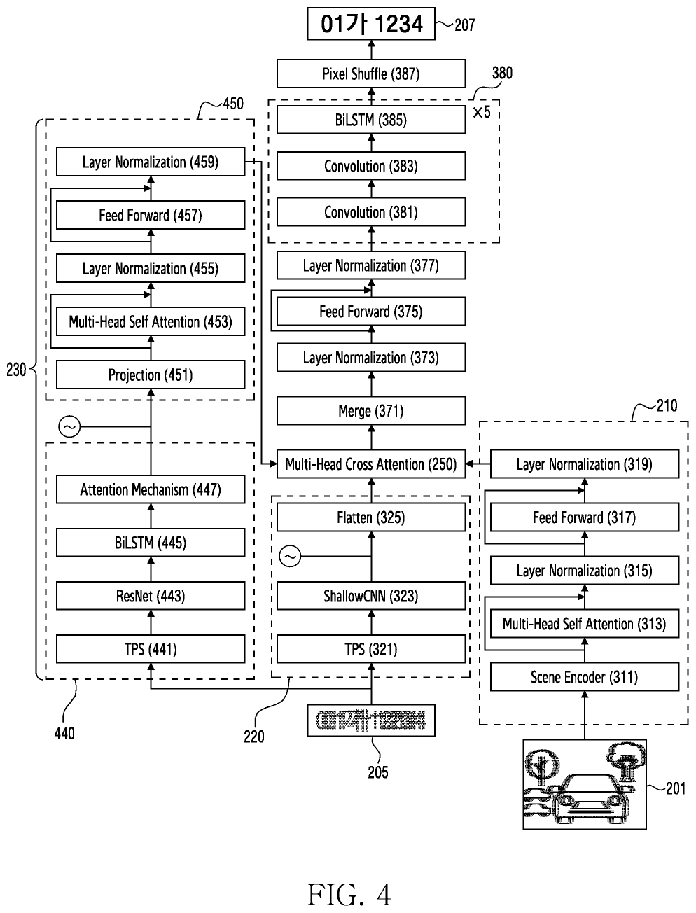

FIG. 4 illustrates an exemplary block diagram of a model for prior knowledge information included in an image restoration model executed by an electronic device 101 according to an embodiment.

The electronic device 101 and/or the processor 110 of FIG. 1 may execute the image restoration model described with reference to FIG. 4 by executing an image restoration program 125.

In a state of processing an entire image 201 and a partial image 205 using the image restoration model, the electronic device 101 may perform a first operation of processing the partial image 205 using an encoder 220, a second operation of processing the entire image 201 using an image encoder 210, and a third operation of processing the partial image 205 using a recognizer 230 in parallel (or substantially simultaneously). The first operation and the second operation may correspond to the first operation and the second operation described with reference to FIG. 3, respectively. The first operation, the second operation, and the third operation may be performed substantially simultaneously by different processors included in the electronic device 101.

Referring to FIG. 4, the recognizer 230 may include a sub-model 440 and a projection model 450. In an embodiment, when executing the sub-model 440, the electronic device 101 may obtain or generate output data (e.g., text probability information and/or a text probability map), by sequentially performing an encoding operation, a sequence modeling operation, a decoding prediction operation, and a linearization operation on the partial image 205. Referring to FIG. 4, one or more operations may be connected to the sub-model 440. The connection of the one or more operations may include a structure of a thin plate spline transformation (TPS)-ResNet-bidirectional long-short term memory (BILSTM)-attention mechanism (TRBA). The connection of the one or more operations of the sub-model 440 may include a connection of a TPS model 441, a ResNet model 443, a BilSTM model 445, and a multi head self attention model 447. An embodiment is not limited thereto, and another structure (or a topology) such as a convolution-recurrent neural network (CRNN), an autonomous, bidirectional and iterative network (ABINet), and/or a permuted autoregressive sequence (PARseq) may be applied to a structure of the sub-model 440.

According to an embodiment, the electronic device 101 may generate or obtain implicit information (e.g., non-categorical information) on the partial image 205 by using the sub-model 440.

According to an embodiment, the electronic device 101 may process the implicit information obtained from the sub-model 440 of the recognizer 230 using the projection model 450. Within the projection model 450, a projection operation 451, a multi head self attention model 453, a first layer normalization model 455, a feed forward model 457, and a second layer normalization model 459 may be sequentially combined. Using the projection model 450, the electronic device 101 may generate or obtain feature information Fₚ∈ [symbol] ^{l×proj} (or prior knowledge information 240) from the implicit information.

Using the sub-model 440 in a state trained based on an operation described with reference to FIG. 4, the electronic device 101 may obtain implicit information p_{NCAP}∈ [symbol] ^{l×embed} from the partial image 205. The implicit information PNCAP may be determined or calculated based on Equation 10.

$${p}_{NCAP} ∈ {ℝ}^{1 \times embed} = pReLU ( {STR}_{stu , dec} ( S T {R}_{stu , enc} ( {x}_{L R} ) ) \cdot {W}_{proj} ) = pReL U ( h \cdot {W}_{proj} ) \qquad [ Equation 10 ]$$

An STR term of Equation 10 means a scene text recognizer, and represents a character recognition technique in a scene image. In addition, the STR_{stu,dec} may represent an operation performed in a decoder (e.g., a group of the BILSTM 445 and the Attention mechanism 447 in the sub-model 440) of the sub-model 440. The STR_{stu,dec} may represent an operation performed by an encoder (e.g., the ResNet 443 in the sub-model 440) of the sub-model 440. The x_{LR} of Equation 10 may represent the partial image 205 with a relatively low resolution.

Using the information (e.g., the p_{NCAP} of Equation 10) obtained through the projection operation 451, the electronic device 101 may obtain, or calculate, feature information Fₚ of Equation 11 from the projection model 450.

$${F}_{p} = ( {p}_{NCAP} + PE ) \cdot {W}_{p} \qquad [ Equation 11 ]$$

By performing a softmax operation and/or a layer normalization operation on the feature information obtained from the projection model 450, the electronic device 101 may obtain or calculate feature information

$${F}_{p}^{′}$$

### of Equation 12.

$${F}_{p}^{′} = LN ( softmax ( \frac{{Q}_{p} {K}_{p}^{T}}{\sqrt{d}} ) {V}_{p} + {F}_{p} \qquad [ Equation 12 ]$$

From the feature information Fₚ and

$${F}_{p}^{′}$$

of Equation 11 and Equation 12, the electronic device 101 may obtain or calculate feature information

$${F}_{p}^{″}$$

### of Equation 13.

$${F}_{p}^{″} = LN ( {F}_{p}^{′} \cdot {W}_{p}^{′} + {F}_{p}^{′} ) \qquad [ Equation 13 ]$$

Equation 13 may correspond to self attention of the

$${F}_{p}^{′}$$

of Equation 12. For the self attention, for example, Equation 13 may be defined to process the feature information

$${F}_{p}^{′}$$

of Equation 12 using a projection and a linearization operation (LN) based on an fc layer. An addition operation

$$( e . g . , the + {F}_{p} operation and / or the + {F}_{p}^{′} operation )$$

of Equation 12 and Equation 13 may represent a residual connection (or identity mapping).

According to an embodiment, the electronic device 101 may perform multi head cross attention between feature information [symbol] ^{c×hw} of the encoder 220 and the feature information Fₚ∈ [symbol] ^{l×proj} of the recognizer 230 in a multi head cross attention model 250 of the image restoration model.

$${F}_{p}^{′′′}$$

of Equation 14 may represent feature information outputted from the multi head cross attention model 250.

$${F}_{p}^{′′′} = softmax ( \frac{{Q}_{v} {K}_{p}^{′ ′ T}}{\sqrt{d}} ) {V}_{p}^{″} \qquad [ Equation 14 ]$$

A query for performing multi head cross attention of Equation 14 may correspond to the feature information Fᵥ∈ [symbol] ^{c×hw} of the encoder 220.

The d of Equation 14 may represent a dimension of a key vector. The Qᵥ of Equation 14, which is a projection of the Fᵥ of Equation 1 (e.g., a projection based on an fc layer), may represent a query vector. The

$${K}_{p}^{″}$$

and the

$${V}_{p}^{″}$$

are the projections (e.g., projections based on the fc layer) of the

$${F}_{p}^{″}$$

of Equation 13, may represent a key vector and a value vector, respectively. The

$${Q}_{v} \cdot {K}_{p}^{″ T}$$

operation of Equation 14 may represent an attention score of self attention. The T operation of Equation 14 may represent a matrix transpose operation.

A key and a value for performing the multi head cross attention of Equation 14 may correspond to low-level feature information having a size of [symbol] ^{l×c} of the feature information of the recognizer 230. The [symbol] ^{l×c} may represent a feature dimension (the number) of a shallow CNN 323. The

$${Q}_{v} \cdot {K}_{p}^{′ ′ T}$$

of Equation 14 may have a size of [symbol] ^{hw×l}, and the

$${Q}_{v} \cdot {K}_{p}^{″ T} \cdot {V}_{p}^{″}$$

of Equation 14 may have a size of [symbol] ^{hw×c}. Referring to Equation 14, the feature information

$${F}_{p}^{′′′}$$

obtained using the softmax operation and the layer normalization (LN) operation may be obtained from the multi-head cross-attention model 250.

With respect to feature information (e.g., the feature information

$${F}_{p}^{′′′}$$

obtained based on Equation 14 and the feature information

$${F}_{g}^{′′′}$$

obtained based on Equation 5) obtained from the multi head cross attention model 250, the electronic device 101 may perform calculations represented by a serial connection of a merge model 371, a first layer normalization model 373, a feedforward model 375, and a second layer normalization model 377.

Referring to FIG. 4, the electronic device 101 may generate (or obtain) combined feature information from the feature information

$${F}_{p}^{′′′}$$

and the feature information

$${F}_{g}^{′′′}$$

through the merge model 371. For example, the electronic device 101 may generate (or obtain) combined feature information [symbol] ^{2c×hw} by concatenating the feature information

$${F}_{p}^{′′′}$$

of the [symbol] ^{2c×hw} and the feature information

$${F}_{g}^{′′′}$$

of the [symbol] ^{2c×hw} through the merge model 371. For example, the electronic device 101 may generate (or obtain) combined feature information [symbol] ^{c×hw}⊕ [symbol] ^{c×hw}= [symbol] ^{c×hw} by element-wise summing the feature information of the

$${F}_{p}^{′′′}$$

of the [symbol] ^{c×hw} and the feature information

$${F}_{g}^{′′′}$$

of the [symbol] ^{c×hw} through the merge model 371. An operation for combining the feature information

$${F}_{p}^{′′′}$$

and the feature information

$${F}_{g}^{′′′}$$

is not limited to the concatenation or the element-wise sum, and based on various operations (e.g., gated fusion), the electronic device 101 may combine the feature information

$${F}_{p}^{′′′}$$

and the feature information

$${F}_{g}^{′′′} .$$

Referring to FIG. 4, a residual connection for an element-wise sum may be formed between the first layer normalization model 373 and the second layer normalization model 377. The residual connection may be formed between the first layer normalization model 373 and the second layer normalization model 377, independently of the feed forward model 375.

When training an image restoration model having a structure of FIG. 4, a loss function to be used for training the image restoration model may represent a difference between a ground truth image corresponding to the partial image 205 and an output image 207. For example, an L1 distance (e.g., a Manhattan distance and/or a rectangular street grid) between the ground truth image and the output image 207 may be determined as the loss function. An embodiment is not limited thereto, and a L2 distance (or mean squared loss), a structural similarity index (SSIM), a triplex SSIM (TSSIM), and a Kullback-Leibler (KL) divergence loss function for knowledge distillation may be used.

According to an embodiment, the electronic device may perform training on the image restoration model using the pre-trained image encoder 210. However, it is not limited thereto. In case that distribution of learning data for pre-training of the entire image 201 and the image encoder 210 is different, the image encoder 210 may also be trained together. According to an embodiment, the electronic device may perform training on the image restoration model using the pre-trained sub-model 440.

The trained image restoration model may be provided as a portion of a software application (e.g., the image restoration program 125 of FIG. 1) for image restoration.

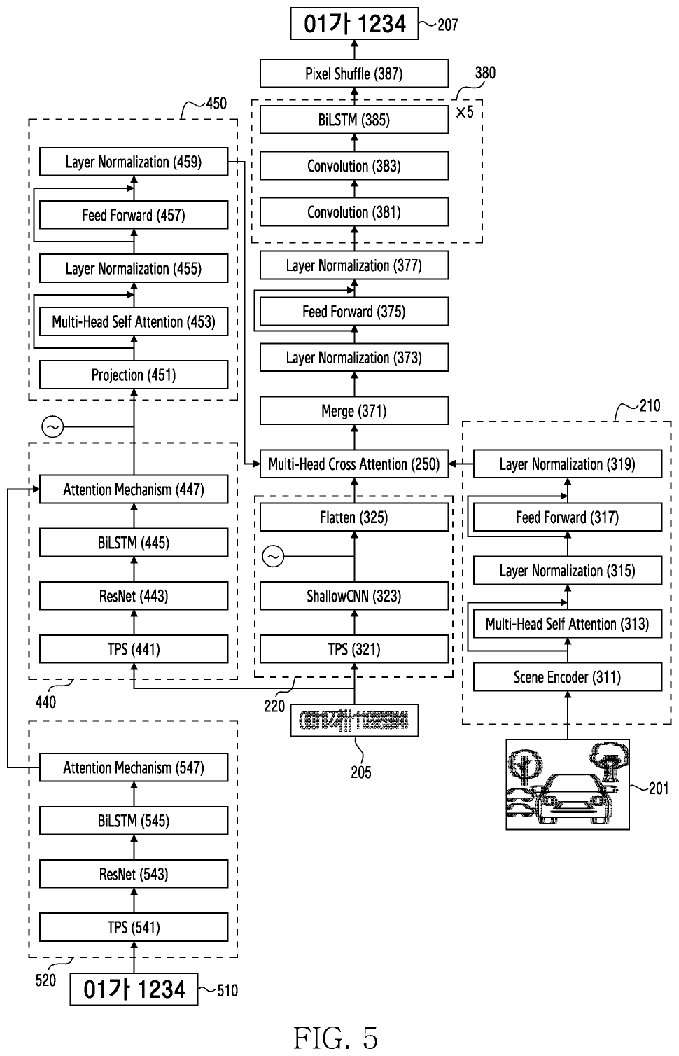

FIG. 5 illustrates an exemplary block diagram of a teacher model connected to a model for prior knowledge information included in an image restoration model executed by an electronic device 101 according to an embodiment.

The electronic device 101 and/or the processor 110 of FIG. 1 may obtain, generate, and/or train the image restoration model described with reference to FIG. 5 by executing an image restoration program 125.

A teacher model 520 of the image restoration model may generate training information (e.g., ground truth data and input data corresponding to the ground truth data) used to train a sub-model 440 using knowledge distilling. Referring to FIG. 5, in the teacher model 520, one or more operations may be connected. The teacher model 520 may have substantially the same structure as a structure in which the one or more operations of the sub-model 440 are connected. For example, the teacher model 520 may have a structure in which a TPS model 541, a ResNet model 543, a BilSTM model 545, and a multi head self attention model 547 are connected. The number of calculations of the sub-model 440 and parameters (e.g., coefficients and/or weights) used in the calculations may be less than the number of calculations of the teacher model 520 and parameters used in the calculations of the teacher model 520. For example, the sub-model 440 may be pretrained by the teacher model 520 executed by using more parameters than those for the sub-model 440. In an embodiment, the teacher model 520 used for training the sub-model 440 may be trained to recognize one or more characters from a scene such as a partial image 205. In terms of recognizing a character, the teacher model 520 may be referred to as a scene-text recognizer (STR) and/or an STR model. The teacher model 520 may be configured to recognize or process a feature such as shapes and/or positions of the one or more characters in an image 201. The sub-model 440 may be referred to as a student model in terms of being trained by the teacher model 520.

Output data of the teacher model 520 receiving a high-resolution image 510 (or x_{HR}) corresponding to the partial image 205 may be represented as Equation 15.

$${t}_{HR} = S T {R}_{tea , dec} ( S T {R}_{tea , enc} ( {x}_{HR} ) ) \cdot {W}_{c , HR} \qquad [ Equation 15 ]$$

The STR_{tea,enc} of Equation 15 may represent an operation performed by an encoder (e.g., the ResNet 543 in the teacher model 520). The STR_{tea,dec} of Equation 15 may represent an operation performed by a decoder (e.g., a group of the BILSTM 545 and an attraction mechanism 547 in a sub-model 540) of the teacher model 520. The W_{c,HR} of Equation 15 may correspond to a matrix representing an operation (e.g., a feed-forward operation) performed in the teacher model 520. The t_{HR} of Equation 15 may represent an output of the teacher model 520 to which the high-resolution image 510 is inputted.

Output data of the sub-model 440 may have a relationship of Equation 16. t_{LR} of Equation 16 may represent an output of the sub-model 440 to which a low-resolution image (or the partial image 205) (or x_{LR}) is inputted. For example, Equation 16 may represent the output data of the sub-model 440 that has received the partial image 205.

$${t}_{LR} ∈ {ℝ}^{1 \times \vert A \vert} = S T {R}_{stu , dec} ( S T {R}_{stu , enc} ( {x}_{LR} ) ) \cdot {W}_{c , LR} \qquad [ Equation 16 ]$$

The t_{LR} of Equation 16 may represent the output of the sub-model 440 to which the low-resolution image is inputted. For example, Equation 16 may represent the output data of the sub-model 440 that has received the partial image 205.

Based on implicit information obtained from the sub-model 440, the electronic device 101 may obtain the p_{NCAP} of Equation 10 from a projector model 450.

When training the sub-model 440, the electronic device 101 may use a loss function [symbol] _{distill} of Equation 17 to reduce a domain gap (e.g., a domain difference between a high-resolution output image 207 and the low-resolution partial image 205) of prior knowledge of the sub-model 440.

$${ℒ}_{distill} = {\vert {t}_{HR} - {t}_{LR} \vert}_{1} + {D}_{KL} ( {t}_{LR} ‖ {t}_{HR} ) \qquad [ Equation 17 ]$$

The t_{HR} of Equation 17 and the t_{LR} of Equation 17 may represent prior knowledge obtained by inputting each of the high-resolution image and the low-resolution image to the STR including the sub-model 440. The t_{HR} of Equation 17 may be generated from the fixed (or freezed) teacher model 520. The t_{LR} of Equation 17 may be generated from the trainable sub-model 440. The loss function of Equation 17 may be determined by another method (e.g., L1 distance).

A loss function [symbol] ₛₜᵣ of the sub-model 440 may be determined by a loss function [symbol] ₐᵤₓ, which maximizes a margin and cross entropy loss (e.g., cross entropy loss for training of the sub-model 440) between text logits information and a correct answer label, as illustrated in Equation 18 below. In an embodiment, the loss function [symbol] ₐᵤₓ may be determined by Equation 19 below. According to an embodiment, the loss function [symbol] ₐᵤₓ may be omitted in Equation 18.

$${ℒ}_{str} = C E ( {p}_{p red} , {y}_{gt} ) + {ℒ}_{a u x} \qquad [ Equation 18 ]$$

The p_{pred} of Equation 18 may represent text logits information obtained by inputting the output image 207 to a text recognition network. The y_{gt} of Equation 18 may represent a correct answer label (e.g., underlying ground truth data) for an image received as an input.

$${ℒ}_{a u x} = - min ( 1 , {\sum }_{t = 1}^{l} {\sum }_{i = 1 , i \neq {p}_{{y}_{t}}}^{\vert A \vert} log ( {p}_{{y}_{t}} - {p}_{t , i} + ϵ ) ) \qquad [ Equation 19 ]$$

The [symbol] ₐᵤₓ of Equation 19 may be defined to obtain a differential feature (or implicit information) using the sub-model 440. The p_{y}_{ₜ} of Equation 19 may represent an output probability of the sub-model 440 corresponding to a character represented as a correct answer by ground truth data, when training the sub-model 440 using the partial image 205 and the ground truth data representing the one or more characters included in the partial image 205. Referring to Equation 19, the p_{t,i} may represent the output probability of the sub-model 440 corresponding to a character that is not the correct answer since it does not match the character for which i is represented as the correct answer (i≠p_{y}_{ₜ}). The ϵ of Equation 19 may be a real number (e.g., 10⁻⁷) defined so that a result value of a log function does not decrease to an excessively small value (e.g., negative infinity). The l of Equation 19 may represent a length of the maximum character string, and i of Equation 19 may be a variable that changes within the total number (|A|) of a class.

The electronic device 101 may further apply a loss function that reduces a difference

between an attention score of the high-resolution image and the low-resolution image and/or a loss function that reduces a difference between probability distribution of the high-resolution image and probability distribution of the low-resolution image. For example, the electronic device 101 may use a loss function to focus on a region related to the one or more characters in the partial image 205. For example, the electronic device 101 may increase a weight for a character string that may be confusing by using a weighted cross entropy (WCE) such as Equation 20.

$${ℒ}_{t x t} = α \cdot {‖ {A}_{H R} - {A}_{S R} ‖}_{1} + β \cdot WC E ( {p}_{pred} , {y}_{g t} ) \qquad [ Equation 20 ]$$

For example, the α of Equation 20 may be set to a numerical value such as 10, and the β may be set to a numerical value such as 0.0005. The ∥A_{HR}−A_{SR}∥₁ of Equation 20 may mean a L1 distance. Each of the A_{HR} and the A_{SR} of Equation 20 may be attention information (or an attention map) for the high-resolution image and attention information (or an attention map) for the output image 207 (e.g., an image restored by the image restoration model), obtained from an additional artificial intelligence model (e.g., the text recognition network) for processing the output image 207. The p_{pred} of Equation 20 may represent text logits information obtained by inputting the output image 207 to the text recognition network. The y_{gt} of Equation 20 may represent ground truth data. The loss function [symbol] ₜₓₜ of Equation 20 may be defined to reduce a difference between the attention information A_{SR} for the output image 207 and the attention information A_{HR} for the high-resolution image.

In an embodiment, the electronic device 101 may at least partially train the image restoration model using a combination of the above-described loss functions (e.g., joint learning). A combination [symbol] ₜₒₜₐₗ of the loss functions may be set as in Equation 21. Using the [symbol] ₜₒₜₐₗ of Equation 21, which is an example of the WCE, backpropagation of the entire model, starting from a pixel shuffle model 387, may be performed. The backpropagation may be performed to reduce an error in the attention map and the logits. For example, the loss function [symbol] ₜₓₜ of Equation 20 may be used to reduce an error between the attention map and the text logits information obtained from the additional artificial intelligence model (e.g., the text recognition network) to process the partial image 205. By the backpropagation, the entire image restoration model may be trained to reduce a difference between the output image 207 and the partial image 205.

$${ℒ}_{total} = {λ}_{I} {ℒ}_{s} + {λ}_{2} {ℒ}_{t s s i m} + {λ}_{3} {ℒ}_{distill} + {λ}_{4} {ℒ}_{str} + {λ}_{5} {ℒ}_{t x t} \qquad [ Equation 21 ]$$

In Equation 21, numerical values such as λ_1=1, λ_2=1, λ_3=0.01, λ_4=0.01, and λ_5=0.5 may be set. An embodiment is not limited thereto. The [symbol] ₛ of Equation 21 may be determined as Equation 8. The [symbol] ₜₛₛᵢₘ of Equation 21 may be defined as Equation 9. The [symbol] _{distill} of Equation 21 may be defined as Equation 17. The [symbol] ₛₜᵣ of Equation 21 may be defined as Equation 18. The [symbol] ₜₓₜ of Equation 21 may be defined as Equation 20.

According to an embodiment, the electronic device 101 may execute the image restoration model including the sub-model 440 and the projection model 450 that may be executed at least temporarily simultaneously with the image encoder 210, the encoder 220, the fusion layer 260, and a decoder operation 270 for restoring the partial image 205. The image encoder 210, the encoder 220, the fusion layer 260, and the decoder operation 270 may be combined with any pre-trained sub-model 440 for recognizing a character. By using the sub-model 440, the electronic device 101 may effectively obtain prior knowledge (or prior information) to be used to restore or enhance the partial image 205.

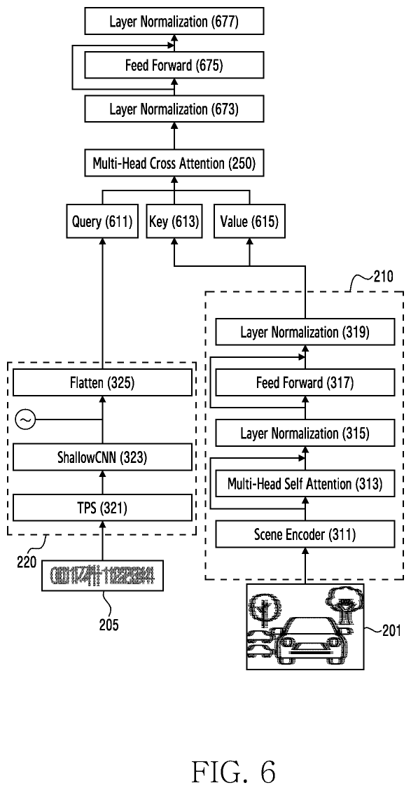

FIG. 6 illustrates an exemplary block diagram of a structure for combining global context information and local information in an image restoration model executed by an electronic device 101 according to an embodiment.

The electronic device 101 and/or the processor 110 of FIG. 1 may execute the image restoration model described with reference to FIG. 6 by executing an image restoration program 125.

In a state of processing an entire image 201 and a partial image 205 using the image restoration model, the electronic device 101 may perform a first operation of processing the partial image 205 using an encoder 220 and a second operation of processing the entire image 201 using an image encoder 210 in parallel (or substantially simultaneously). The first operation and the second operation may correspond to the first operation and the second operation described with reference to FIG. 3, respectively. The first operation and the second operation may be performed substantially simultaneously by different processors included in the electronic device 101.

According to an embodiment, the electronic device 101 may perform multi head cross attention between low-level feature information

$${F}_{p}^{′′′} ∈ {ℝ}^{c \times h w}$$

of the encoder 220 and global context information

$${F}_{g}^{′′′} ∈ {ℝ}^{1 \times c}$$

of the image encoder 210. In an embodiment, the electronic device 101 may perform the multi head cross attention between the low-level feature information

$${F}_{p}^{′′′} ∈ {ℝ}^{c \times hw}$$

of the encoder 220 and the global context information

$${F}_{g}^{′′′} ∈ {ℝ}^{1 \times c}$$

of the image encoder 210 based on Equation 5. In an embodiment, a query 611 for performing the multi head cross attention may correspond to the low-level feature information

$${F}_{p}^{′′′} ∈ {ℝ}^{c \times hw}$$

of the encoder 220. A key 613 and a value 615 for performing the multi head cross attention of Equation 5 may correspond to the global context information

$${F}_{g}^{′′′} ∈ {ℝ}^{1 \times c} .$$

With respect to feature information obtained from a multi head cross attention model 250, the electronic device 101 may perform calculations represented by a serial connection of a first layer normalization model 673, a feedforward model 675, and a second layer normalization model 677. Referring to FIG. 6, a residual connection for an element-wise sum may be formed between the first layer normalization model 673 and the second layer normalization model 677. The residual connection may be formed between the first layer normalization model 673 and the second layer normalization model 677, independently of the feed forward model 675.

In an embodiment, the electronic device 101 may obtain an output image 207 by inputting feature information outputted from the second layer normalization model 677 to a decoder 270.

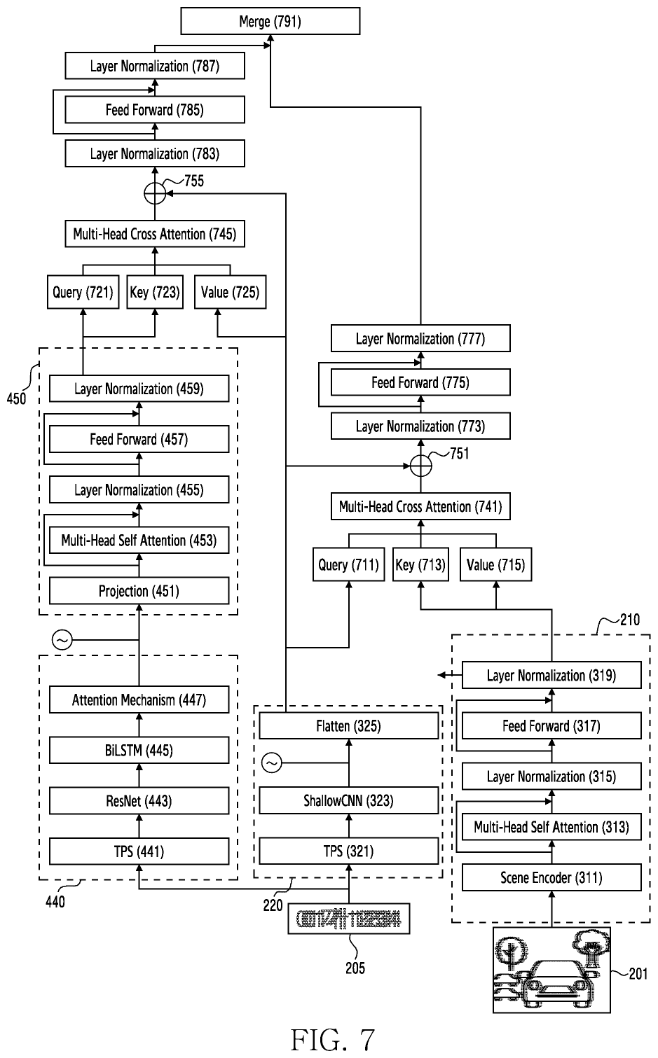

FIG. 7 illustrates an exemplary block diagram of a structure for combining global context information, local information, and prior knowledge information in an image restoration model executed by an electronic device 101 according to an embodiment.

The electronic device 101 and/or the processor 110 of FIG. 1 may execute the image restoration model described with reference to FIG. 7 by executing an image restoration program 125.

In a state of processing an entire image 201 and a partial image 205 using the image restoration model, the electronic device 101 may perform a first operation of processing the partial image 205 using a encoder 220, a second operation of processing the entire image 201 using an image encoder 210, and a third operation of processing the partial image 205 using a recognizer 230 in parallel (or substantially simultaneously). The first operation and the second operation may correspond to the first operation and the second operation described with reference to FIG. 3, respectively. The third operation may correspond to the third operation described with reference to FIG. 4. The first operation, the second operation, and the third operation may be performed substantially simultaneously by different processors included in the electronic device 101.

According to an embodiment, the electronic device 101 may perform multi head cross attention between low-level feature information [symbol] ^{c×hw} of the encoder 220 and global context information [symbol] ^{1×c} of the image encoder 210 in a multi-head cross-attention model 741 of the image restoration model. In an embodiment, the electronic device 101 may perform the multi head cross attention between the low-level feature information [symbol] ^{c×hw} of the encoder 220 and the global context information [symbol] ^{c×hw} of the image encoder 210 based on Equation 2. In an embodiment, a query 711 for performing the multi head cross attention may correspond to the low-level feature information [symbol] ^{c×hw} of the encoder 220. A key 713 and a value 715 for performing the multi head cross attention of Equation 2 may correspond to the global context information [symbol] ^{l×c}.

The electronic device 101 may combine feature information

$${F}_{g}^{′′′}$$

obtained from the multi head cross attention model 741 with the low-level feature information [symbol] ^{c×hw} (or the query 711). For example, the electronic device 101 may generate (or obtain) a combined feature information [symbol] ^{c×hw}⊕ [symbol] ^{c×hw}= [symbol] ^{c×hw} by element-wise summing [symbol] ^{c×hw} and the low-level feature information [symbol] ^{c×hw} (or the query 711) through a merge model 751. Feature information F_{g}″ of the [symbol] ^{c×hw} and feature information of the low-level feature information [symbol] ^{c×hw} may be referred to as first combined feature information.

With respect to the feature information F_{g}″ combined through the merge model 751, the electronic device 101 may perform calculations represented by a serial connection between a first layer normalization model 773, a feedforward model 775, and a second layer normalization model 777. Referring to FIG. 7, a residual connection for the element-wise sum may be formed between the first layer normalization model 773 and the second layer normalization model 777. The residual connection may be formed between the first layer normalization model 773 and the second layer normalization model 777, independently of the feed forward model 775.

According to an embodiment, the electronic device 101 may perform multi head cross attention between the low-level feature information [symbol] ^{c×hw} of the encoder 220 and prior knowledge information [symbol] ^{1×c} of the recognizer 230 in a multi head cross attention model 745 of the image restoration model. In an embodiment, the electronic device 101 may perform the multi head cross attention between the low-level feature information [symbol] ^{c×hw} of the encoder 220 and the prior knowledge information [symbol] ^{1×c} of the recognizer 230 based on Equation 2. In an embodiment, a query 721 for performing the multi head cross attention may correspond to the low-level feature information [symbol] ^{c×hw} of the encoder 220. A key 723 and a value 725 for performing the multi head cross attention of Equation 2 may correspond to the prior knowledge information [symbol] ^{l×c}.

The electronic device 101 may combine the feature information

$${F}_{p}^{″}$$

obtained from the multi head cross attention model 745 with the low-level feature information [symbol] ^{c×hw} (or the query 721). For example, the electronic device 101 may generate (or obtain) a combined feature information [symbol] ^{c×hw}⊕ [symbol] ^{c×hw}= [symbol] ^{c×hw} by element-wise summing the feature information

$${F}_{p}^{″}$$

and the low-level feature information [symbol] ^{c×hw} through a merge model 755. Feature information in which the feature information

$${F}_{p}^{″}$$

of the [symbol] ^{c×hw} and the low-level feature information [symbol] ^{c×hw} are combined may be referred to as second combined feature information.

With respect to the feature information

$${F}_{p}^{″}$$

combined through the merge model 755, the electronic device 101 may perform calculations represented by a serial connection of a third layer normalization model 783, a feedforward model 785, and a fourth layer normalization model 787. Referring to FIG. 7, a residual connection for the element-wise sum may be formed between the third layer normalization model 783 and the fourth layer normalization model 787. The residual connection may be formed between the third layer normalization model 783 and the fourth layer normalization model 787, independently of the feed forward model 785.

Referring to FIG. 7, the electronic device 101 may generate (or obtain) third combined feature information from the first combined feature information and the second combined feature information through a merge model 791. For example, the electronic device 101 may generate (or obtain) the third combined feature information [symbol] ^{2c×hw} by concatenating the first combined feature information of the [symbol] ^{c×hw} and the second combined feature information of the [symbol] ^{c×hw}. For example, the electronic device 101 may generate (or obtain) the third combined feature information of the [symbol] ^{c×hw} by element-wise summing the first combined feature information of the [symbol] ^{c×hw} and the second combined feature information of the [symbol] ^{c×hw}.

In an embodiment, the electronic device 101 may obtain an output image 207 by inputting the third combined feature information to a decoder 270.

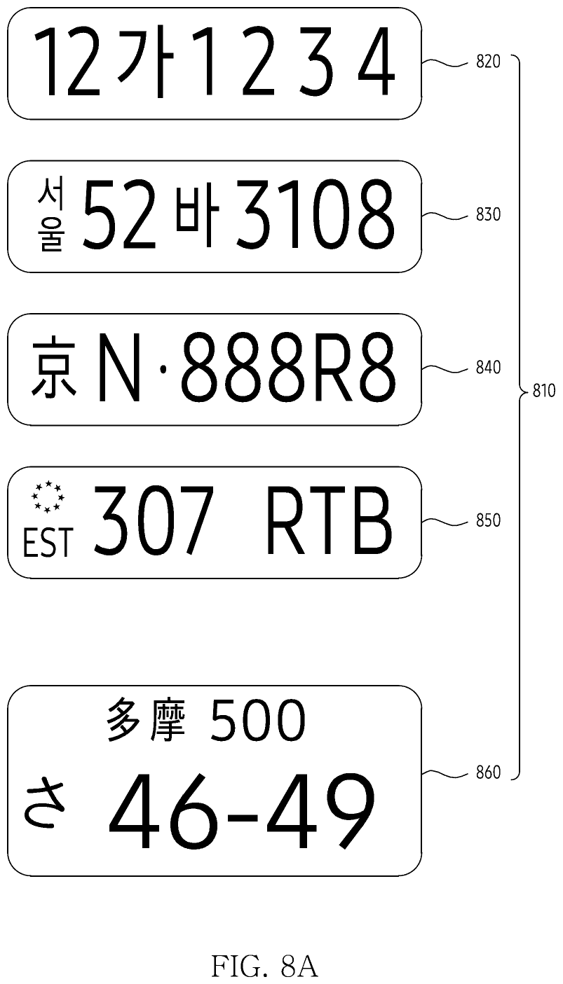

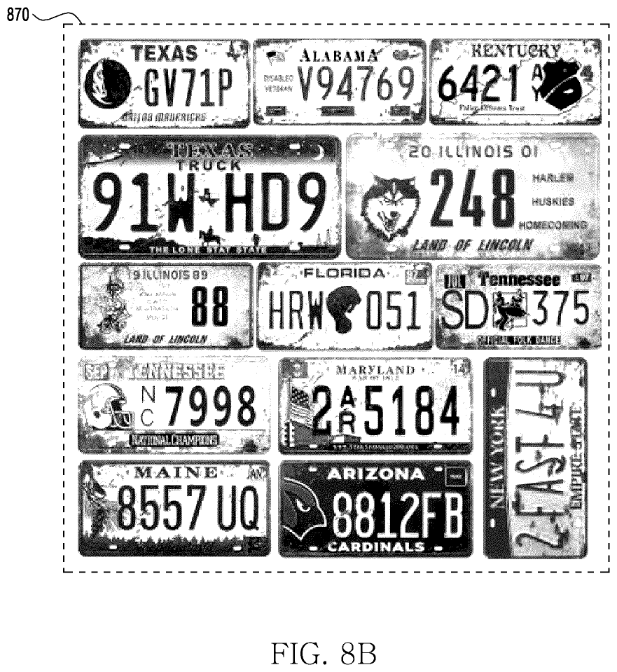

FIGS. 8A and 8B illustrate at least one license plate (or number plate), which is a subject included in an image restored by an image restoration model according to an embodiment.

Referring to FIG. 8A, images 810 including at least one license plate obtained from the image restoration model are illustrated. The images 810 may be outputted from, or provided by, an electronic device 101 that executes the image restoration model as a result of restoring or enhancing a low-resolution input image (e.g., the input image 205 of FIG. 2).

For example, the electronic device 101 may generate an image 820 including a license plate based on the law of the Republic of Korea. The image 820 may include numbers (e.g., 12) indicating a type of a vehicle, an alphabet (e.g., “ [symbol] ”) indicating a purpose of the vehicle, and numbers (e.g., 1234) indicating a serial number uniquely assigned to the vehicle. For example, the electronic device 101 may obtain an image 830 including the license plate based on the law of the Republic of Korea. The image 830 may further include, with respect to the image 820, characters (e.g., a place name such as “Seoul”) indicating an area associated with the license plate. A background color of the license plate represented through the images 820 and 830 may indicate a category (e.g., a private vehicle) of the vehicle defined by the law of the Republic of Korea.

For example, the electronic device 101 may generate an image 840 including a license plate based on the law of China. In the image 840, a character (e.g., [symbol] ) indicating an area associated with the license plate and a character (e.g., N) indicating a city (e.g., a sub-area of the area) associated with the license plate may include information on the area or purpose. The image 840 may include serial numbers (e.g., 888R8) uniquely assigned to a vehicle. A color of the license plate represented through the image 840 may indicate a category (e.g., a passenger car, a large vehicle, a bus, a truck, and/or a motorcycle) of the vehicle.

For example, the electronic device 101 may generate an image 850 including a license plate based on the law of the European Union. The image 850 may include a symbol indicating the European Union, characters (e.g., EST) indicating an area associated with the license plate, and serial numbers (e.g., “307 RTB”) uniquely assigned to a vehicle on which the license plate is mounted. An embodiment is not limited thereto, and the image 850 may further include a flag of a country in which the vehicle on which the license plate is mounted is registered as a country affiliated with the European Union.

For example, the electronic device 101 may generate an image 860 including a license plate based on the law of Japan. The image 860 may include characters (e.g., [symbol] ) indicating a region, numbers (e.g., 500) indicating a category of a vehicle, a character indicating a purpose of a business associated with the vehicle, and serial numbers (e.g., 46-49) uniquely assigned to the vehicle on which the license plate is mounted.

Referring to FIG. 8B, images 870 including a license plate based on the law of the United States generated by the electronic device according to an embodiment are illustrated. Referring to the images 870, based on the law of the United States, the license plate including an image and/or a figure defined by a state government of the United States may be generated. The license plate may include text (e.g., “TEXAS”, “ALABAMA”, “KENTUCKY”, and the like) indicating a state government together with an image and/or a figure indicating the state government in which a vehicle is registered. Together with the text, the image representing the license plate may include a serial number (e.g., a combination of alphabets and/or numbers such as “GV71P”) uniquely assigned to the vehicle.

In an embodiment, a method of increasing or enhancing a resolution of an image in a specified portion (e.g., a license plate) in which one or more characters are captured from the entire image using a model trained to output feature information through the entire image including abundant information, may be required.

As described above, an electronic device may comprise memory storing instructions. The electronic device may comprise at least one processor configured to execute the instructions. The instructions, when executed by the at least one processor individually or collectively, may cause the electronic device to receive a request to restore a second input image with a first resolution representing a specified portion of a first input image to an output image with a second resolution exceeding the first resolution. The instructions, when executed by the at least one processor individually or collectively, may cause the electronic device to, based on the received request, execute an image restoration model including a first encoder for extracting first feature information from the first input image, a second encoder for extracting second feature information from the second input image, and a decoder for generating the output image with the second resolution based on multi head cross attention between the first feature information and the second feature information. The instructions, when executed by the at least one processor individually or collectively, may cause the electronic device to provide the output image with the second resolution obtained based on the execution of the image restoration model, as a response to the request.

According to an embodiment, the electronic device may increase or enhance a resolution of an image of a specified portion (e.g., a license plate) in which one or more characters are captured from the entire image using a model trained to output feature information through the entire image including abundant information.

The multi head cross attention may be obtained by using one of the first feature information or the second feature information as a query, and using the other of the first feature information or the second feature information as a key and a value.

The instructions, when executed by the at least one processor individually or collectively, may cause the electronic device to, based on the received request, execute the image restoration model including a sub model trained to output a text probability map representing one or more characters associated with the second input image and a fusion layer for combining the multi head cross attention and another multi head cross attention between the text probability map and the second feature information. The decoder may be configured to generate the output image with the second resolution based on the another multi head cross attention and the multi head cross attention.

The second encoder may be trained using feature information generated by a teacher model, which is used to train the sub model using knowledge distillation.

The instructions, when executed by the at least one processor individually or collectively, may cause the electronic device to, based on the received request, execute the image restoration model including a first multi head cross attention model for generating the multi head cross attention using the first feature information as a key and a value, and the second feature information as a query, and a second multi head cross attention model for generating the other multi head cross attention using the text probability map as a key and a value, and the second feature information as a query.

The fusion layer may be configured to combine the multi head cross attention and the first feature information, combine the other multi head cross attention and the first feature information, and combine the multi head cross attention combined with the first feature information, and the other multi head cross attention combined with the first feature information.

The first encoder may be an image encoder of a pre learned image-language model, and the second encoder may comprise an encoder configured to extract feature information at a lower level than that of the image encoder.

According to an embodiment, a method executed in an electronic device may comprise receiving a request to restore a second input image with a first resolution representing a specified portion of a first input image to an output image with a second resolution exceeding the first resolution. The method may comprise, based on the received request, executing an image restoration model including a first encoder for extracting first feature information from the first input image, a second encoder for extracting second feature information from the second input image, and a decoder for generating the output image with the second resolution based on multi head cross attention between the first feature information and the second feature information. The method may comprise providing the output image with the second resolution obtained based on the execution of the image restoration model, as a response to the request.

The multi head cross attention may be obtained by using one of the first feature information or the second feature information as a query, and using the other of the first feature information or the second feature information as a key and a value.

The executing the image restoration model may comprise, based on the received request, executing the image restoration model including a sub model trained to output a text probability map representing one or more characters associated with the second input image, and a fusion layer for combining the multi head cross attention and another multi head cross attention between the text probability map and the second feature information.

The second encoder may be trained using feature information generated by a teacher model, which is used to train the sub model using knowledge distillation.

The executing the image restoration model may comprise, based on the received request, executing the image restoration model including a first multi head cross attention model for generating the multi head cross attention using the first feature information as a key and a value, and the second feature information as a query, and a second multi head cross attention model for generating the other multi head cross attention using the text probability map as a key and a value, and the second feature information as a query.

The fusion layer may be configured to combine the multi head cross attention and the first feature information, combine the other multi head cross attention and the first feature information, combine the multi head cross attention combined with the first feature information, and the other multi head cross attention combined with the first feature information.

The first encoder may be an image encoder of a pre learned image-language model, and the second encoder may comprise an encoder configured to extract feature information at a lower level than that of the image encoder.

As described above, in a non-transitory computer readable storage medium comprising instructions, the instructions may be configured, when executed by at least one processor of an electronic device individually or collectively, to cause the electronic device to receive a request to restore a second input image with a first resolution representing a specified portion of a first input image to an output image with a second resolution exceeding the first resolution. The instructions may be configured, when executed by the at least one processor individually or collectively, to cause the electronic device to, based on the received request, execute an image restoration model including a first encoder for extracting first feature information from the first input image, a second encoder for extracting second feature information from the second input image, and a decoder for generating the output image with the second resolution based on multi head cross attention between the first feature information and the second feature information. The instructions may be configured, when executed by the at least one processor individually or collectively, to cause the electronic device to, provide the output image with the second resolution obtained based on the execution of the image restoration model, as a response to the request.

The multi head cross attention may be obtained by using one of the first feature information or the second feature information as a query, and using the other of the first feature information or the second feature information as a key and a value.

The instructions may be configured, when executed by the at least one processor individually or collectively, to cause the electronic device to, based on the received request, execute the image restoration model including a sub model trained to output a text probability map representing one or more characters associated with the second input image, and a fusion layer for combining the multi head cross attention and another multi head cross attention between the text probability map and the second feature information. The decoder may be configured to generate the output image with the second resolution based on the another multi head cross attention and the multi head cross attention.

The second encoder may be trained using feature information generated by a teacher model, which is used to train the sub model using knowledge distillation.

The instructions may be configured, when executed by the at least one processor individually or collectively, to cause the electronic device to, based on the received request, execute the image restoration model including a first multi head cross attention model for generating the multi head cross attention using the first feature information as a key and a value, and the second feature information as a query, and a second multi head cross attention model for generating the other multi head cross attention using the text probability map as a key and a value, and the second feature information as a query.

As described above, a method executed in an electronic device may comprise, by using a first input image, a second input image with a first resolution representing a specified portion of the first input image, and a ground truth image with a second resolution exceeding the first resolution, executing training of an image restoration model including a first encoder for extracting first feature information from the first input image, a second encoder for extracting second feature information from the second input image, and a decoder for generating the output image with the second resolution, based on multi head cross attention between the first feature information and the second feature information. The method may comprise providing the image restoration model, as a portion of a software application for restoring of an image. The method may comprise executing training of the second encoder, based on loss between the output image and the ground truth image.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

1. An electronic device comprising:
memory storing instructions; and
at least one processor configured to execute the instructions,
wherein the instructions, when executed by the at least one processor individually or collectively, cause the electronic device to:
receive a request to restore a second input image with a first resolution representing a specified portion of a first input image to an output image with a second resolution exceeding the first resolution;
based on the received request, execute an image restoration model including:
a first encoder for extracting first feature information from the first input image;
a second encoder for extracting second feature information from the second input image; and
a decoder for generating the output image with the second resolution based on multi head cross attention between the first feature information and the second feature information; and
provide the output image with the second resolution obtained based on the execution of the image restoration model, as a response to the request.

2. The electronic device of claim 1,
wherein the multi head cross attention is obtained by using one of the first feature information or the second feature information as a query, and using the other of the first feature information or the second feature information as a key and a value.

3. The electronic device of claim 1,
wherein the instructions, when executed by the at least one processor individually or collectively, cause the electronic device to:
based on the received request, execute the image restoration model including:
a sub model trained to output a text probability map representing one or more characters associated with the second input image; and
a fusion layer for combining the multi head cross attention and another multi head cross attention between the text probability map and the second feature information, and
wherein the decoder is configured to generate the output image with the second resolution based on the another multi head cross attention and the multi head cross attention.

4. The electronic device of claim 3,
wherein the second encoder is trained using feature information generated by a teacher model, which is used to train the sub model using knowledge distillation.

5. The electronic device of claim 3,
wherein the instructions, when executed by the at least one processor individually or collectively, cause the electronic device to:
based on the received request, execute the image restoration model including:
a first multi head cross attention model for generating the multi head cross attention using the first feature information as a key and a value, and the second feature information as a query; and
a second multi head cross attention model for generating the other multi head cross attention using the text probability map as a key and a value, and the second feature information as a query.

6. The electronic device of claim 3,
wherein the fusion layer is configured to:
combine the multi head cross attention and the first feature information,
combine the other multi head cross attention and the first feature information,
combine the multi head cross attention combined with the first feature information, and the other multi head cross attention combined with the first feature information.

7. The electronic device of claim 1,
wherein the first encoder is an image encoder of a pre learned image-language model, and
wherein the second encoder comprises an encoder configured to extract feature information at a lower level than that of the image encoder.

8. A method executed in an electronic device, comprising:
receiving a request to restore a second input image with a first resolution representing a specified portion of a first input image to an output image with a second resolution exceeding the first resolution;
based on the received request, executing an image restoration model including:
a first encoder for extracting first feature information from the first input image;
a second encoder for extracting second feature information from the second input image; and
a decoder for generating the output image with the second resolution based on multi head cross attention between the first feature information and the second feature information; and
providing the output image with the second resolution obtained based on the execution of the image restoration model, as a response to the request.

9. The method of claim 8,
wherein the multi head cross attention is obtained by using one of the first feature information or the second feature information as a query, and using the other of the first feature information or the second feature information as a key and a value.

10. The method of claim 8, wherein executing the image restoration model comprises:
based on the received request, executing the image restoration model including:
a sub model trained to output a text probability map representing one or more characters associated with the second input image; and
a fusion layer for combining the multi head cross attention and another multi head cross attention between the text probability map and the second feature information, and
wherein the decoder is configured to generate the output image with the second resolution based on the another multi head cross attention and the multi head cross attention.

11. The method of claim 10,
wherein the second encoder is trained using feature information generated by a teacher model, which is used to train the sub model using knowledge distillation.

12. The method of claim 10, wherein executing the image restoration model comprises:
based on the received request, executing the image restoration model including:
a first multi head cross attention model for generating the multi head cross attention using the first feature information as a key and a value, and the second feature information as a query; and
a second multi head cross attention model for generating the other multi head cross attention using the text probability map as a key and a value, and the second feature information as a query.

13. The method of claim 10,
wherein the fusion layer is configured to:
combine the multi head cross attention and the first feature information,
combine the other multi head cross attention and the first feature information,
combine the multi head cross attention combined with the first feature information, and the other multi head cross attention combined with the first feature information.

14. The method of claim 8,
wherein the first encoder is an image encoder of a pre learned image-language model, and
wherein the second encoder comprises an encoder configured to extract feature information at a lower level than that of the image encoder.

15. A non-transitory computer readable storage medium, comprising instructions,
wherein the instructions are configured, when executed by at least one processor of an electronic device individually or collectively, to cause the electronic device to:
receive a request to restore a second input image with a first resolution representing a specified portion of a first input image to an output image with a second resolution exceeding the first resolution;
based on the received request, execute an image restoration model including:
a first encoder for extracting first feature information from the first input image;
a second encoder for extracting second feature information from the second input image; and
a decoder for generating the output image with the second resolution based on multi head cross attention between the first feature information and the second feature information; and
provide the output image with the second resolution obtained based on the execution of the image restoration model, as a response to the request.

16. The non-transitory computer readable storage medium of claim 15,
wherein the multi head cross attention is obtained by using one of the first feature information or the second feature information as a query, and using the other of the first feature information or the second feature information as a key and a value.

17. The non-transitory computer readable storage medium of claim 15,
wherein the instructions, when executed by the at least one processor individually or collectively, cause the electronic device to:
based on the received request, execute the image restoration model including:
a sub model trained to output a text probability map representing one or more characters associated with the second input image; and
a fusion layer for combining the multi head cross attention and another multi head cross attention between the text probability map and the second feature information, and
wherein the decoder is configured to generate the output image with the second resolution based on the another multi head cross attention and the multi head cross attention.

18. The non-transitory computer readable storage medium of claim 17,
wherein the second encoder is trained using feature information generated by a teacher model, which is used to train the sub model using knowledge distillation.

19. The non-transitory computer readable storage medium of claim 17,
wherein the instructions, when executed by the at least one processor individually or collectively, cause the electronic device to:
based on the received request, execute the image restoration model including:
a first multi head cross attention model for generating the multi head cross attention using the first feature information as a key and a value, and the second feature information as a query; and
a second multi head cross attention model for generating the other multi head cross attention using the text probability map as a key and a value, and the second feature information as a query.

20. The non-transitory computer readable storage medium of claim 17,
wherein the fusion layer is configured to:
combine the multi head cross attention and the first feature information,
combine the other multi head cross attention and the first feature information,
combine the multi head cross attention combined and the first feature information, and
combine the other multi head cross attention combined and the first feature information.
